(19) United States
(12) Patent Application Publication
(10) Pub. No.: US 2017/0220109 A1
(43) Pub. Date: Aug. 3, 2017

(54) BLINK TYPE DETERMINATION METHOD AND APPARATUS, USER EQUIPMENT

(71) Applicant: Beijing Zhigu Rui Tuo Tech Co., Ltd, Beijing (CN)

(72) Inventor: Hao LIU, Beijing (CN)

(21) Appl. No.: 15/502,496

(22) PCT Filed: Jul. 24, 2015
(86) PCT No.: PCT/CN2015/085001

§ 371 Date: Feb. 7, 2017

(30) Foreign Application Priority Data
Aug. 8, 2014 (CN) 201410389697.6

(51) Int. Cl. G06F 3/01; G06N 99/00; G06F 1/16

(52) U.S. Cl. CPC G06F 3/013; G06F 3/015; G06F 1/163; G06N 99/005

(57) ABSTRACT

A blink type determination method and a determination apparatus are disclosed. A method comprises: acquiring an electrooculogram waveform signal of a blink of a user; determining whether a blink type of the blink can be determined according to an amplitude peak value of the electrooculogram waveform signal and a corresponding relationship between amplitude peak value and blink type; and in response to that the blink type of the blink cannot be determined according to the amplitude peak value and the corresponding relationship, matching the electrooculogram waveform signal according to at least one electrooculogram signal waveform pattern, to determine the blink type of the blink. When a blink type of a blink cannot be determined according to an amplitude peak value of an electrooculogram waveform signal of the blink, the blink type is determined through waveform pattern matching, taking into account accuracy and/or efficiency of blink type detection.

### RELATED APPLICATION

The present international patent cooperative treaty (PCT) application claims the benefit of priority to Chinese Patent Application No. 201410389697.6, filed on Aug. 8, 2014, and entitled “Blink Type Determining Method and Blink Type Determining Apparatus”, which is hereby incorporated into the present international PCT application by reference herein in its entirety.

### TECHNICAL FIELD

The present application relates to eye movement examination technologies, and in particular, to a blink type determination method and apparatus.

### BACKGROUND

With technological development, means of human-computer interaction is also increasing, and from manual interaction such as keyboards, mouse and touch screens to voice, eye movement and the like, human-computer interaction becomes more and more traversal. For example, a user equipment such as smart glasses can use a blink of a user as a control input for triggering photographing, which eliminates a cumbersome process of using a photograph button and a voice command, and greatly improves use convenience of the user.

However, blinks of the user are divided into unconscious blinks and conscious blinks, the conscious blinks can be used as input control signals of smart glasses, and the unconscious blinks should be removed as noise due to uncontrollability, so as to avoid affecting smart glass use experience of the user.

### SUMMARY

An example, non-limiting objective of the present application is to provide a technical solution of determining a blink type.

In a first aspect, one example embodiment of the present application provides a blink type determination method, comprising:

acquiring an electrooculogram waveform signal of a blink of a user;

determining whether a blink type of the blink can be determined according to an amplitude peak value of the electrooculogram waveform signal and a corresponding relationship between amplitude peak value and blink type; and

in response to that the blink type of the blink cannot be determined according to the amplitude peak value and the corresponding relationship, matching the electrooculogram waveform signal according to at least one electrooculogram signal waveform pattern, to determine the blink type of the blink.

In a second aspect, one example embodiment of the present application provides a blink type determination apparatus, comprising:

a signal acquisition module, configured to acquire an electrooculogram waveform signal of a blink of a user;

a first determination module, configured to determine whether a blink type of the blink can be determined according to an amplitude peak value of the electrooculogram waveform signal and a corresponding relationship between amplitude peak value and blink type; and

a second determination module, configured to, in response to that the blink type of the blink cannot be determined according to the amplitude peak value and the corresponding relationship, match the electrooculogram waveform signal according to at least one electrooculogram signal waveform pattern, to determine the blink type of the blink.

In a third aspect, one example embodiment of the present application provides a user equipment, comprising the blink type determination apparatus in the foregoing implementation solution.

In a fourth aspect, one example embodiment of the present application provides a computer readable storage device comprising executable instructions that, in response to execution, cause a device comprising a processor to perform operations, comprising:

acquiring an electrooculogram waveform signal of a blink of a user;

determining whether a blink type of the blink can be determined according to an amplitude peak value of the electrooculogram waveform signal and a corresponding relationship between amplitude peak value and blink type; and

in response to that the blink type of the blink cannot be determined according to the amplitude peak value and the corresponding relationship, matching the electrooculogram waveform signal according to at least one electrooculogram signal waveform pattern, to determine the blink type of the blink.

At least one of the embodiments of the present application, when a blink type of a blink cannot be determined according to an amplitude peak value of an electrooculogram waveform signal of the blink, determines the blink type through waveform pattern matching, which takes into account both accuracy and efficiency of blink type detection.

### BRIEF DESCRIPTION OF THE DRAWINGS

FIG. 1 is a schematic flowchart of a blink type determination method according to one example embodiment of the present application;

FIG. 2 is a schematic diagram of a corresponding relationship between amplitude peak value and blink type in a blink type determination method according to one example embodiment of the present application;

FIG. 3 is a schematic structural diagram of a blink type determination apparatus according to one example embodiment of the present application;

FIGS. 4a and 4b are respectively schematic structural diagrams of two apparatuses for determining a blink type according to one example embodiment of the present application;

FIG. 4c is a schematic structural diagram of a signal acquisition module of a blink type determination apparatus according to one example embodiment of the present application;

FIG. 5 is a schematic structural diagram of a user equipment according to one example embodiment of the present application; and

FIG. 6 is a schematic structural diagram of a blink type determination apparatus according to one example embodiment of the present application.

### DETAILED DESCRIPTION

Example embodiments of the present application are described in detail hereinafter with reference to the accompanying drawings and embodiments (in which the same elements are denoted by the same reference numerals). The following embodiments are intended to describe the present application, but not to limit the scope of the present application.

It should be understood by those skilled in the art that the terms such as “first” and “second” are merely intended to distinguish different steps, devices or modules, etc., which neither represent any particular technical meaning nor indicate a necessary logical sequence between them.

It is noted that, as amplitude peak value ranges corresponding to conscious blink and unconscious blink respectively have an overlapping region, accuracy degree will be reduced when conscious blink and unconscious blink are distinguished through an amplitude peak value of an electrooculogram waveform signal, and for an amplitude peak value located in the overlapping region, a blink type corresponding thereto cannot be accurately determined, which may lead to spurious triggering of a blink control signal.

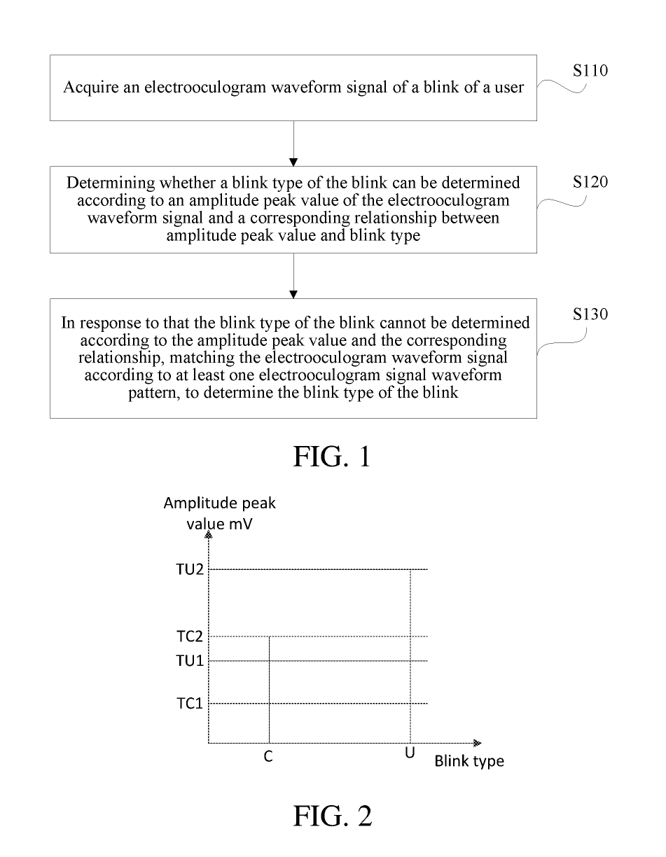

As shown in FIG. 1, one example embodiment of the present application provides a blink type determination method, comprising:

S110 acquiring an electrooculogram waveform signal of a blink of a user;

S120 determining whether a blink type of the blink can be determined according to an amplitude peak value of the electrooculogram waveform signal and a corresponding relationship between amplitude peak value and blink type; and

S130 in response to that the blink type of the blink cannot be determined according to the amplitude peak value and the corresponding relationship, matching the electrooculogram waveform signal according to at least one electrooculogram signal waveform pattern, to determine the blink type of the blink.

For example, a blink type determination apparatus provided in the present application serves as an execution body of this embodiment, to perform S110-S130. Specifically, the blink type determination apparatus may be disposed in a user equipment through software, hardware or a combination thereof, or the blink type determination apparatus per se is the user equipment; the user equipment comprises, but is not limited to: a computer, a tablet computer, a smart phone, smart glasses, a smart helmet, a smart wristband, a smart ring and the like, wherein the smart glasses comprise smart frame glasses and smart contact lenses.

The example embodiment of the present application, when a blink type of a blink cannot be determined according to an amplitude peak value of an electrooculogram waveform signal of the blink, determines the blink type through waveform pattern matching, which takes into account both accuracy and efficiency of blink type detection.

The steps of the method in the embodiment of the present application are further described through the following implementation:

S110 Acquire an electrooculogram waveform signal of a blink of a user.

In the embodiment of the present application, the electrooculogram waveform signal can be acquired in many manners, for example, in one example embodiment, step S110 comprises:

collecting the electrooculogram waveform signal.

In the example embodiment, for example, at least one electrooculogram signal can be collected through an electrooculogram sensor. Generally, the electrooculogram sensor comprises a plurality of electrode slices, configured to adjoin a plurality of positions around eyes of a user, for example, the plurality of electrode slices is respectively disposed in positions such as angulus oculi medialis, angulus oculi lateralis, above and below the eyelid of a measured eye of the user, and the middle of the forehead, configured to collect electrooculogram signals produced by eye movement of the user.

In some example embodiments, the electrode slices may be embedded in and integrated to a frame of frame glasses, to facilitate the user to use. Therefore, in the example embodiment, optionally, the user equipment may be the smart frame glasses and the smart helmet, and the electrooculogram sensor may be integrated to the smart frame glasses or the smart helmet.

In another example embodiment of the present application, step S110 comprises:

acquiring the electrooculogram waveform signal from at least one external device.

In the example embodiment, for example, the at least one electrooculogram waveform signal can be received from at least one external device through a communication device of the blink type determination apparatus. For example, the blink type determination apparatus can be disposed in a user equipment such as a computer, a tablet computer, a mobile phone or a smart watch, the user further wears an electrooculogram collection apparatus, and the blink type determination apparatus can obtain the electrooculogram signal from the electrooculogram collection apparatus through the communication device.

S120 Determine whether a blink type of the blink can be determined according to an amplitude peak value of the electrooculogram waveform signal and a corresponding relationship between amplitude peak value and blink type.

In one example embodiment of the present application, the blink type comprises: an unconscious blink and a conscious blink.

In one example embodiment of the present application, the corresponding relationship between amplitude peak value and blink type comprises:

a first amplitude peak value range corresponding to the unconscious blink;

a second amplitude peak value range corresponding to the conscious blink; and

a third amplitude peak value range simultaneously corresponding to the unconscious blink and the conscious blink.

As shown in FIG. 2, FIG. 2 is one possible schematic diagram of an amplitude peak value range U corresponding to an unconscious blink and an amplitude peak value range C corresponding to a conscious blink. It can be seen from FIG. 2 that, amplitude peak values corresponding to the amplitude peak value range U corresponding to the unconscious blink are TU1-TU2, amplitude peak values corresponding to the amplitude peak value range C corresponding to the conscious blink are TC1-TC2, and it can be known from FIG. 2 that the amplitude peak value range U and the amplitude peak value range C have an overlapping amplitude peak value range TU1-TC2. Therefore, in the embodiment of the present application, the first amplitude peak value range is TC1-TU1, the second amplitude peak value range is TC2-TU2, and the overlapping amplitude peak value range TU1-TC2 is the third amplitude peak value range.

Those skilled in the art can know that, according to the FIG. 2, when amplitude peak values of an electrooculogram waveform signal corresponding to a blink of the user acquired are respectively within the ranges of TC1-TU1 and TC2-TU2, it can be determined that blinks corresponding to the electrooculogram waveform signal are respectively an unconscious blink and a conscious blink, but the type of the blink cannot be accurately determined when the amplitude peak values of the electrooculogram waveform signal are within the range of TU1-TC2. Therefore, it is necessary to find another method to determine the blink type for an electrooculogram waveform signal whose amplitude peak value falls within the overlapping range.

In one example embodiment of the present application, amplitude peak value ranges corresponding to various blink types may be general values obtained by making statistics on blink conditions of a plurality of users.

It is noted that, as electroconductibility of human body skin, blink environments and amplitudes and ranges of eye movement of different users are different, amplitude peak value ranges corresponding to conscious blinks and/or unconscious blinks of different users may be different; therefore, in the determination of a blink type of a blink of a user, accuracy degree and efficiency of use of a corresponding relationship between personalized amplitude peak value and blink type of the user will be higher. Therefore, in another example embodiment of the present application, the corresponding relationship is a corresponding relationship between personalized amplitude peak value and blink type of the user.

In one example embodiment, the corresponding relationship may be historical data acquired from an external device or read from a local storage device.

In another example embodiment, the method further comprises:

obtaining the corresponding relationship between personalized amplitude peak value and blink type by learning.

For example, when the user uses the blink type determination apparatus, the user is prompted to maintain an unconscious blink for a period of time (according to statistics, normal persons make unconscious blinks a dozen times per minute on average, and will often blink once every 2-6 s, and every blink takes 0.2-0.4 s) and make conscious blinks multiple times; and electrooculogram waveform signals of multiple unconscious blinks and multiple conscious blinks configured for training are recorded and a corresponding relationship between personalized amplitude peak value and blink type of the user is learned therefrom, for example, the relationship comprising: an amplitude peak value range of an electrooculogram waveform signal of a conscious blink of the user, and an amplitude peak value range of an electrooculogram waveform signal of an unconscious blink of the user.

In one example embodiment, if the personalized corresponding relationship needs to be applied to the process that the user uses the blink type determination apparatus in future, the personalized corresponding relationship can be associated with the user and maintained in a storage device.

As stated above, when the corresponding relationship comprises the three amplitude peak value ranges stated above, in one example embodiment of the present application, step S120 may comprise:

determining which amplitude peak value range the amplitude peak value corresponds to, wherein

in response to that the amplitude peak value corresponds to the third amplitude peak value range, the blink type of the blink cannot be determined according to the amplitude peak value and the corresponding relationship.

Certainly, correspondingly, in response to that the amplitude peak value does not correspond to the third amplitude peak value range, the blink type of the blink can be determined according to the amplitude peak value and the corresponding relationship.

Optionally, in one example embodiment, the method further comprises:

in response to that the blink type of the blink can be determined according to the amplitude peak value and the corresponding relationship, determining the blink type of the blink according to the amplitude peak value and the corresponding relationship.

When the corresponding relationship is the three amplitude peak value ranges stated above, in response to that the amplitude peak value corresponds to the first amplitude peak value range, the blink type of the blink is determined as the unconscious blink; and

in response to that the amplitude peak value corresponds to the second amplitude peak value range, the blink type of the blink is determined as the conscious blink.

S130 In response to that the blink type of the blink cannot be determined according to the amplitude peak value and the corresponding relationship, match the electrooculogram waveform signal according to at least one electrooculogram signal waveform pattern, to determine the blink type of the blink.

In one example embodiment of the present application, the at least one electrooculogram signal waveform pattern comprises at least one of the following: an unconscious blink waveform pattern and a conscious blink waveform pattern. For example, the at least one electrooculogram signal waveform pattern is the unconscious blink waveform pattern, or the conscious blink waveform pattern, or the unconscious blink waveform pattern and the conscious blink waveform pattern.

By taking that the at least one electrooculogram signal waveform pattern is the unconscious blink waveform pattern as an example, at this time, step S130, for example, may comprise:

matching the electrooculogram waveform signal with the unconscious blink waveform pattern, and if the electrooculogram waveform signal matches the unconscious blink waveform pattern, determining that the blink corresponding to the electrooculogram waveform signal is the unconscious blink; and otherwise, if the electrooculogram waveform signal does not match the unconscious blink waveform pattern, determining that the blink is the conscious blink.

Similarly, in one example embodiment, the at least one electrooculogram signal waveform pattern may also be a general mode obtained by training and making statistics on blink conditions of a plurality of users.

In another example embodiment, due to individual differences of different users, when a blink type of a user is determined, accuracy degree and efficiency of using a personalized electrooculogram signal waveform pattern of the user for pattern matching will be higher. Therefore, in another example embodiment of the present application, the at least one electrooculogram signal waveform pattern is at least one personalized electrooculogram signal waveform pattern corresponding to the user.

Similarly, in one example embodiment, the at least one personalized electrooculogram signal waveform pattern corresponding to the user may be acquired from an external or internal storage.

Alternatively, in one example embodiment, the method further comprises:

obtaining the at least one personalized electrooculogram signal waveform pattern by learning.

In one example embodiment, in the process of obtaining the corresponding relationship between personalized amplitude peak value and blink type of the user, the at least one personalized electrooculogram signal waveform pattern can be obtained.

It can be seen from the above that, the efficiency of determining the blink type solely through the amplitude peak value of the electrooculogram waveform signal is higher, but due to the overlapping region stated above, the determined accuracy rate will decrease; when the corresponding blink type of the electrooculogram waveform signal is determined solely through electrooculogram signal waveform pattern matching, the efficiency is lower for the electrooculogram waveform signals for which the blink types can be accurately determined through amplitude peak values. Therefore, the method in the embodiment of the present application determines the corresponding blink type for the electrooculogram waveform signal for which the blink type can be accurately determined through the amplitude peak value by using the corresponding relationship between amplitude peak value and blink type, and determines the corresponding blink type for the electrooculogram waveform signal for which the blink type cannot be accurately determined through the amplitude peak value through waveform matching, which takes into account both efficiency and accuracy.

It should be understood by those skilled in the art that, in the method of the specific implementation of the present application, the value of the serial number of each step described above does not mean an execution sequence, and the execution sequence of each step should be determined according to the function and internal logic thereof, and should not be any limitation to the implementation process of the specific implementation of the present application.

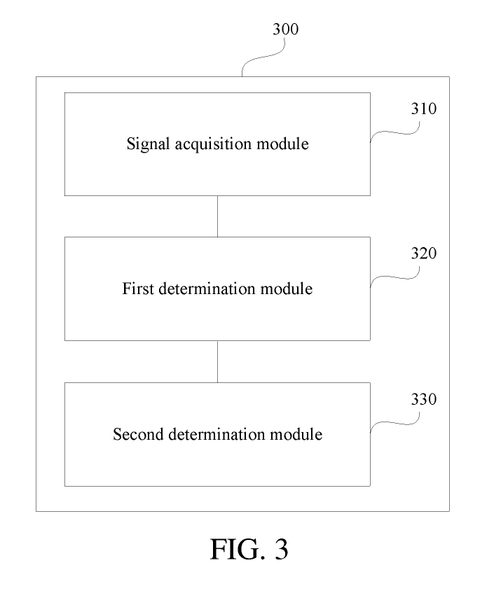

As shown in FIG. 3, one example embodiment of the present application further provides a blink type determination apparatus 300, comprising:

a signal acquisition module 310, configured to acquire an electrooculogram waveform signal of a blink of a user;

a first determination module 320, configured to determine whether a blink type of the blink can be determined according to an amplitude peak value of the electrooculogram waveform signal and a corresponding relationship between amplitude peak value and blink type; and

a second determination module 330, configured to, in response to that the blink type of the blink cannot be determined according to the amplitude peak value and the corresponding relationship, match the electrooculogram waveform signal according to at least one electrooculogram signal waveform pattern, to determine the blink type of the blink.

The example embodiment of the present application, when a blink type of a blink cannot be determined according to an amplitude peak value of an electrooculogram waveform signal of the blink, determines the blink type through waveform pattern matching, which takes into account both accuracy and efficiency of blink type detection.

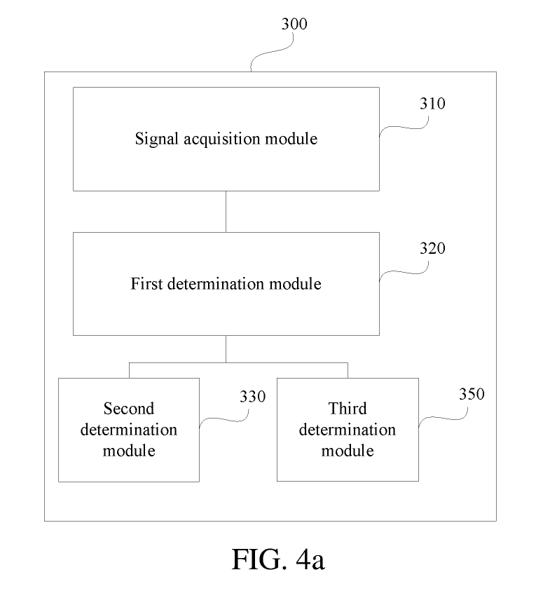

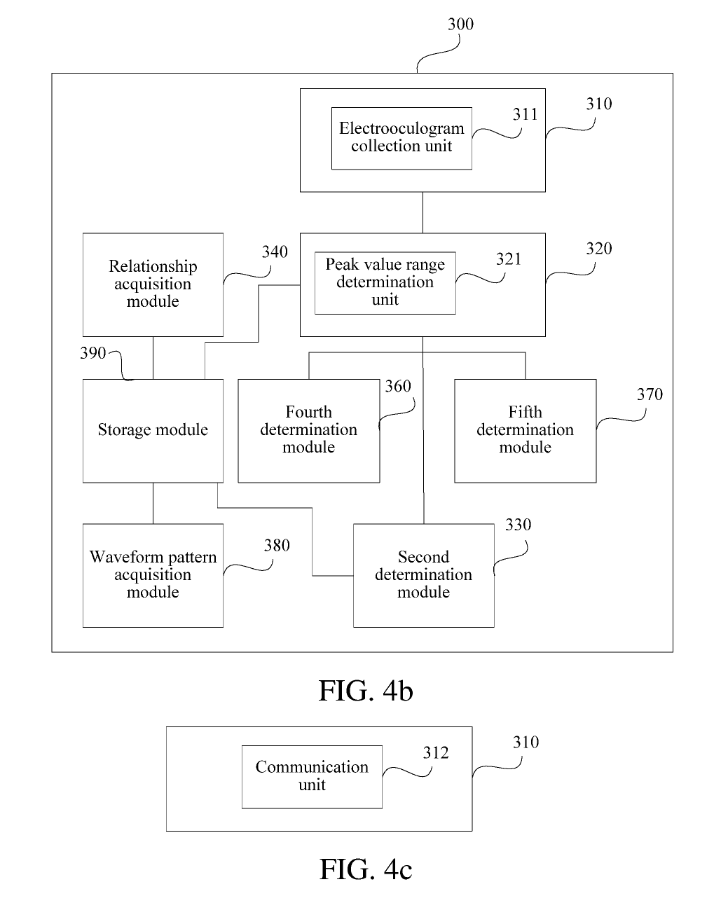

As shown in FIG. 4a, in one example embodiment, the apparatus 300 further comprises:

a third determination module 350, configured to, in response to that the blink type of the blink can be determined according to the amplitude peak value and the corresponding relationship, determine the blink type of the blink according to the amplitude peak value and the corresponding relationship.

As the efficiency of determining the blink type solely through the amplitude peak value of the electrooculogram waveform signal is higher, but due to the overlapping region stated above, the determined accuracy rate will decrease; when the corresponding blink type of the electrooculogram waveform signal is determined solely through electrooculogram signal waveform pattern matching, the efficiency is lower for the electrooculogram waveform signals for which the blink types can be accurately determined through amplitude peak values. Therefore, in the example embodiment, the corresponding blink type of the electrooculogram waveform signal for which the blink type can be accurately determined through the amplitude peak value can be determined through the amplitude peak value, and the corresponding blink type of the electrooculogram waveform signal for which the blink type cannot be accurately determined is determined through the following pattern matching, which takes into account both efficiency and accuracy of determination of the blink type.

The modules of the apparatus in the embodiment of the present application are further described through the following implementation.

As shown in FIG. 4b, in one example embodiment, the signal acquisition module 310 comprises:

an electrooculogram collection unit 311, configured to collect the electrooculogram waveform signal.

In the example embodiment, the electrooculogram collection unit 311, for example, may comprise a plurality of electrode slices, configured to adjoin a plurality of positions around eyes of a user, for example, the plurality of electrode slices is respectively disposed in positions such as angulus oculi medialis, angulus oculi lateralis, above and below the eyelid of a measured eye of the user, and the middle of the forehead, configured to collect electrooculogram signals produced by eye movement of the user. In some example embodiments, the electrode slices may be embedded in and integrated to a frame of frame glasses, to facilitate the user to use.

As shown in FIG. 4c, in another example embodiment, the signal acquisition module 310 comprises:

a communication unit 312, configured to acquire the electrooculogram waveform signal from at least one external device.

In the example embodiment, for example, the at least one electrooculogram waveform signal can be received from at least one external device through the communication unit 312. For example, the blink type determination apparatus can be disposed in a user equipment such as a computer, a tablet computer, a mobile phone or a smart watch, the user further wears an electrooculogram collection apparatus, and the signal acquisition module 310 can obtain the electrooculogram signal from the electrooculogram collection apparatus through the communication unit 312.

In one example embodiment of the present application, the blink type comprises: an unconscious blink and a conscious blink.

In one example embodiment of the present application, the corresponding relationship between amplitude peak value and blink type comprises:

a first amplitude peak value range corresponding to the unconscious blink;

a second amplitude peak value range corresponding to the conscious blink; and

a third amplitude peak value range simultaneously corresponding to the unconscious blink and the conscious blink.

Reference can be made to the description in the corresponding embodiment of FIG. 2 in the foregoing method embodiment for one possible corresponding relationship between amplitude peak value and blink type, which is not repeated herein.

In one example embodiment of the present application, amplitude peak value ranges corresponding to various blink types may be general values obtained by making statistics on blink conditions of a plurality of users.

It is noted that, as electroconductibility of human body skin, blink environments and amplitudes and ranges of eye movement of different users are different, amplitude peak value ranges corresponding to conscious blinks and/or unconscious blinks of different users may be different; therefore, when a blink type of a user is determined, accuracy degree and efficiency of use of a corresponding relationship between personalized amplitude peak value and blink type of the user will be higher. Therefore, in another example embodiment of the present application, the corresponding relationship is a corresponding relationship between personalized amplitude peak value and blink type of the user.

In one example embodiment, the corresponding relationship may be historical data acquired from an external device or read from a local storage device.

In another example embodiment, as shown in FIG. 4b, the apparatus 300 further comprises:

a relationship acquisition module 340, configured to obtain the corresponding relationship between personalized amplitude peak value and blink type by learning.

For example, when the user uses the blink type determination apparatus, the relationship acquisition module 340 prompts the user to maintain an unconscious blink for a period of time and make conscious blinks multiple times; and records electrooculogram waveform signals of multiple unconscious blinks and multiple conscious blinks configured for training and learns a corresponding relationship between personalized amplitude peak value and blink type of the user therefrom, for example, comprising: an amplitude peak value range of an electrooculogram waveform signal of a conscious blink of the user, and an amplitude peak value range of an electrooculogram waveform signal of an unconscious blink of the user.

In one example embodiment, the apparatus further comprises a storage module 390, configured to store the corresponding relationship. The corresponding relationship stored by the storage module 390 can be configured to determine the following blink type of the user.

As shown in FIG. 4b, as stated above, when the corresponding relationship is the three amplitude peak value ranges stated above, in one example embodiment, the first determination module 320 comprises:

a peak value range determination unit 321, configured to determine which amplitude peak value range the amplitude peak value corresponds to, wherein

in response to that the amplitude peak value corresponds to the third amplitude peak value range, the blink type of the blink cannot be determined according to the amplitude peak value and the corresponding relationship.

Certainly, correspondingly, when determining whether the blink type can be determined according to the amplitude peak value and the corresponding relationship, the peak value range determination unit 321, in response to that the amplitude peak value does not correspond to the third amplitude peak value range, can determine the blink type of the blink according to the amplitude peak value and the corresponding relationship.

As shown in FIG. 4b, in one example embodiment, when the corresponding relationship is the three amplitude peak value ranges stated above, the apparatus 300 further comprises:

a fourth determination module 360, configured to, in response to that the amplitude peak value corresponds to the first amplitude peak value range, determine the blink type of the blink as the unconscious blink; and

a fifth determination module 370, configured to, in response to that the amplitude peak value corresponds to the second amplitude peak value range, determine the blink type of the blink as the conscious blink.

In one example embodiment of the present application, the at least one electrooculogram signal waveform pattern comprises at least one of the following: an unconscious blink waveform pattern and a conscious blink waveform pattern. For example, the at least one electrooculogram signal waveform pattern is the unconscious blink waveform pattern, or the conscious blink waveform pattern, or the unconscious blink waveform pattern and the conscious blink waveform pattern.

By taking that the at least one electrooculogram signal waveform pattern is the unconscious blink waveform pattern as an example, at this time, the second determination module 330 is further configured to:

match the electrooculogram waveform signal through the unconscious blink waveform pattern, and if the electrooculogram waveform signal matches the unconscious blink waveform pattern, determine that the blink corresponding to the electrooculogram waveform signal is the unconscious blink; and otherwise, if the electrooculogram waveform signal does not match the unconscious blink waveform pattern, determine that the blink is the conscious blink.

Similarly, in one example embodiment, the at least one electrooculogram signal waveform pattern may also be a general mode obtained by training and making statistics on blink conditions of a plurality of users.

In another example embodiment, due to individual differences of different users, when a blink type of a user is determined, accuracy degree and efficiency of using a personalized electrooculogram signal waveform pattern of the user for pattern matching will be higher. Therefore, in another example embodiment of the present application, the at least one electrooculogram signal waveform pattern is at least one personalized electrooculogram signal waveform pattern corresponding to the user.

In the example embodiment, the apparatus 300 may further comprise:

a waveform pattern acquisition module 380, configured to obtain the at least one personalized electrooculogram signal waveform pattern by learning.

In one example embodiment, in the process of obtaining the corresponding relationship between personalized amplitude peak value and blink type of the user, the waveform pattern acquisition module 380 may perform pattern learning on the obtained electrooculogram waveform signals of multiple unconscious blinks and multiple conscious blinks, to obtain the at least one personalized electrooculogram signal waveform pattern.

In one example embodiment, the storage module 390 is further configured to store the at least one electrooculogram signal waveform pattern.

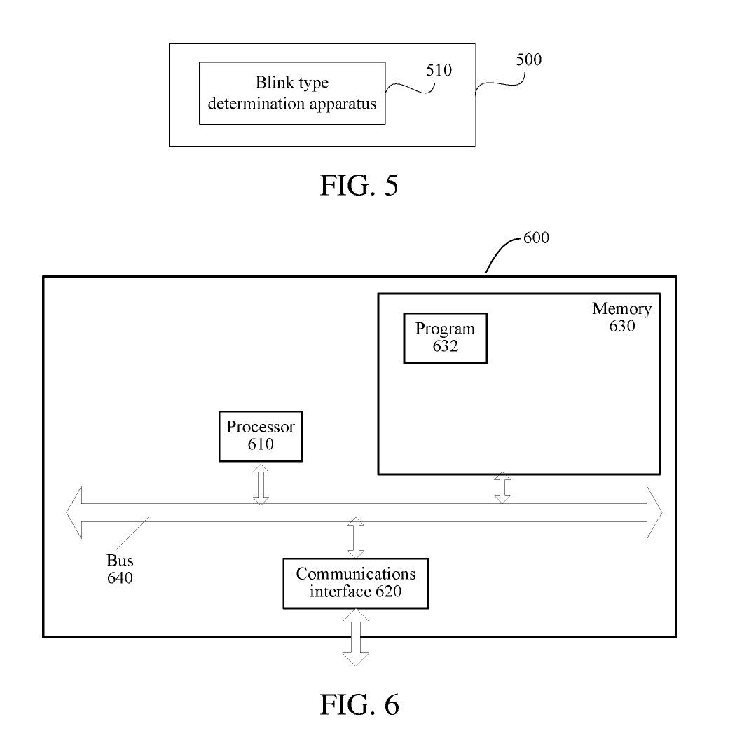

As shown in FIG. 5, FIG. 5 illustrates a user equipment 500 provided in one example embodiment of one embodiment of the present application, which can comprise any blink type determination apparatus 510 stated above.

In the embodiment of the present application, the user equipment 500, for example, may be an electronic device stated above, such as a computer, a tablet computer, a smart phone, smart glasses, a smart helmet, a smart wristband, or a smart ring.

FIG. 6 is a schematic structural diagram of another blink type determination apparatus 600 provided in one embodiment of the present application; the specific embodiment of the present application makes no limitations to specific implementation of the blink type determination apparatus 600. As shown in FIG. 6, the blink type determination apparatus 600 may comprise:

a processor 610, a communications interface 620, a memory 630, and a communications bus 640.

The processor 610, the communications interface 620, and the memory 630 accomplish mutual communications via the communications bus 640.

The communications interface 620 is configured to communicate with a network element such as a client.

The processor 610 is configured to execute a program 632, and specifically, can implement relevant steps in the method embodiments.

Specifically, the program 632 may comprise a program code, the program code comprising a computer operation instruction.

The processor 610 may be a central processing unit (CPU), or an application specific integrated circuit (ASIC), or be configured to be one or more integrated circuits which implement the embodiments of the present application.

The memory 630 is configured to store the program 632. The memory 630 may comprise a high-speed RAM memory, and may also comprise a non-volatile memory, for example, at least one magnetic disk memory. The program 632 may be specifically configured to cause the blink type determination apparatus 600 to implement the following steps:

acquiring an electrooculogram waveform signal of a blink of a user;

determining whether a blink type of the blink can be determined according to an amplitude peak value of the electrooculogram waveform signal and a corresponding relationship between amplitude peak value and blink type; and

in response to that the blink type of the blink cannot be determined according to the amplitude peak value and the corresponding relationship, matching the electrooculogram waveform signal according to at least one electrooculogram signal waveform pattern, to determine the blink type of the blink.

Reference can be made to the corresponding description in the corresponding steps and units in the embodiments for specific implementation of the steps in the program 632, which is not repeated herein. Those skilled in the art can clearly understand that, reference can be made to the corresponding process description in the method embodiments for the devices described above and the specific working procedures of the modules, and will not be repeated herein in order to make the description convenient and concise.

It can be appreciated by those of ordinary skill in the art that each exemplary unit and method step described with reference to the embodiments disclosed herein can be implemented by electronic hardware or a combination of computer software and electronic hardware. Whether these functions are executed in a hardware mode or a software mode depends on particular applications and design constraint conditions of the technical solution. The professional technicians can use different methods to implement the functions described with respect to each particular application, but such implementation should not be considered to go beyond the scope of the present application.

If the functions are implemented in the form of a software functional unit and is sold or used as an independent product, it can be stored in a computer-readable storage medium. Based on such understanding, the technical solution of the present application essentially or the part which contributes to the prior art or a part of the technical solution can be embodied in the form of a software product, and the computer software product is stored in a storage medium, and comprises several instructions for enabling a computer device (which can be a personal computer, a server, or a network device, and the like) to execute all or some steps of the method described in each embodiment of the present application. The foregoing storage medium comprises, a USB disk, a removable hard disk, a read-only memory (ROM), a random access memory (RAM), a magnetic disk, an optical disk or any other mediums that can be configured to store program codes.

The above implementations are only intended to describe the present application rather than to limit the present application; various changes and variations can be made by those of ordinary skill in the art without departing from the spirit and scope of the present application, so all equivalent technical solutions also belong to the category of the present application, and the scope of patent protection of the present application should be defined by the claims.

What is claimed is:

1. A method, comprising:
acquiring, by a system comprising a processor, an electrooculogram waveform signal of a blink of a user;
determining whether a blink type of the blink is capable of being determined according to an amplitude peak value of the electrooculogram waveform signal and a corresponding relationship between amplitude peak value and the blink type; and
in response to determining that the blink type of the blink is unable to be determined according to the amplitude peak value and the corresponding relationship, matching the electrooculogram waveform signal according to at least one electrooculogram signal waveform pattern, to determine the blink type of the blink.

2. The method of claim 1, wherein the blink type comprises: an unconscious blink or a conscious blink.

3. The method of claim 2, wherein the corresponding relationship comprises:
a first amplitude peak value range corresponding to the unconscious blink;
a second amplitude peak value range corresponding to the conscious blink; or
a third amplitude peak value range simultaneously corresponding to the unconscious blink and the conscious blink.

4. The method of claim 3, wherein the determining whether the blink type of the blink is capable of being determined comprises:
determining to which amplitude peak value range the amplitude peak value corresponds, and
wherein, in response to determining that the amplitude peak value corresponds to the third amplitude peak value range, determining the blink type of the blink is unable to be determined according to the amplitude peak value and the corresponding relationship.

5. The method of claim 1, wherein the corresponding relationship is a corresponding relationship corresponding to a personalized amplitude peak value of the user and the blink type.

6. The method of claim 5, further comprising:
obtaining the corresponding relationship between the personalized amplitude peak value and the blink type by learning.

7. The method of claim 2, wherein the at least one electrooculogram signal waveform pattern comprises at least one of an unconscious blink waveform pattern or a conscious blink waveform pattern.

8. The method of claim 1, wherein the at least one electrooculogram signal waveform pattern is at least one personalized electrooculogram signal waveform pattern corresponding to the user.

9. The method of claim 8, further comprising:
obtaining the at least one personalized electrooculogram signal waveform pattern by learning.

10. The method of claim 1, further comprising:
in response to determining that the blink type of the blink is capable of being determined according to the amplitude peak value and the corresponding relationship, determining the blink type of the blink according to the amplitude peak value and the corresponding relationship.

11. The method of claim 4, further comprising:
in response to determining that the amplitude peak value corresponds to the first amplitude peak value range, determining the blink type of the blink as the unconscious blink.

12. The method of claim 4, further comprising:
in response to determining that the amplitude peak value corresponds to the second amplitude peak value range, determining the blink type of the blink as the conscious blink.

13. The method of claim 1, wherein the acquiring the electrooculogram waveform signal comprises:
collecting the electrooculogram waveform signal.

14. The method of claim 1, wherein the acquiring the electrooculogram waveform signal comprises:
acquiring the electrooculogram waveform signal from at least one external device.

15. An apparatus, comprising:
a memory that stores executable modules; and
a processor, couple to the memory, that executes or facilitates execution of the executable modules, the executable modules comprising:
a signal acquisition module configured to acquire an electrooculogram waveform signal of a blink of a user;
a first determination module configured to determine whether a blink type of the blink can be determined according to an amplitude peak value of the electrooculogram waveform signal and a corresponding relationship between the amplitude peak value and the blink type; and
a second determination module configured to, in response to a determination that the blink type of the blink cannot be determined according to the amplitude peak value and the corresponding relationship, match the electrooculogram waveform signal according to at least one electrooculogram signal waveform pattern, to determine the blink type of the blink.

16. The apparatus of claim 15, wherein the blink type comprises: an unconscious blink or a conscious blink.

17. The apparatus of claim 16, wherein the corresponding relationship comprises:
a first amplitude peak value range corresponding to the unconscious blink;
a second amplitude peak value range corresponding to the conscious blink; or
a third amplitude peak value range simultaneously corresponding to the unconscious blink and the conscious blink.

18. The apparatus of claim 17, wherein the first determination module comprises:
a peak value range determination unit configured to determine to which amplitude peak value range the amplitude peak value corresponds, and
wherein, in response to a determination that the amplitude peak value corresponds to the third amplitude peak value range, determining that the blink type of the blink cannot be determined according to the amplitude peak value and the corresponding relationship.

19. The apparatus of claim 15, wherein the corresponding relationship is a corresponding relationship corresponding to a personalized amplitude peak value of the user and the blink type; and
the executable modules further comprise:
a relationship acquisition module configured to obtain the corresponding relationship between a personalized amplitude peak value and the blink type by learning.

20. The apparatus of claim 16, wherein the at least one electrooculogram signal waveform pattern comprises at least one of an unconscious blink waveform pattern or a conscious blink waveform pattern.

21. The apparatus of claim 15, wherein the at least one electrooculogram signal waveform pattern is at least one personalized electrooculogram signal waveform pattern corresponding to the user; and
the executable modules further comprise:
a waveform pattern acquisition module configured to obtain the at least one personalized electrooculogram signal waveform pattern by learning.

22. The apparatus of claim 15, wherein the executable modules further comprise:
a third determination module configured to, in response to a determination that the blink type of the blink can be determined according to the amplitude peak value and the corresponding relationship, determine the blink type of the blink according to the amplitude peak value and the corresponding relationship.

23. The apparatus of claim 18, wherein the executable modules further comprise:
a fourth determination module configured to, in response to a determination that the amplitude peak value corresponds to the first amplitude peak value range, determine the blink type of the blink as the unconscious blink.

24. The apparatus of claim 18, wherein the executable modules further comprise:
a fifth determination module configured to, in response to a determination that the amplitude peak value corresponds to the second amplitude peak value range, determine the blink type of the blink as the conscious blink.

25. The apparatus of claim 15, wherein the signal acquisition module comprises:
an electrooculogram collection unit configured to collect the electrooculogram waveform signal.

26. The apparatus of claim 16, wherein the signal acquisition module comprises:
a communication unit configured to acquire the electrooculogram waveform signal from at least one external device.

27. The apparatus of claim 15, wherein the executable modules further comprise:
a storage module configured to store at least one of the corresponding relationship or the at least one electrooculogram signal waveform pattern.

28. A user equipment, comprising the apparatus of claim 15.

29. A computer readable storage device comprising executable instructions that, in response to execution, cause a device comprising a processor to perform operations, comprising:
acquiring an electrooculogram waveform signal of a blink of a user;
determining whether a blink type of the blink is ascertainable according to an amplitude peak value of the electrooculogram waveform signal and a corresponding relationship between amplitude peak value and blink type; and
in response to determining that the blink type of the blink is unable to be ascertained according to the amplitude peak value and the corresponding relationship, matching the electrooculogram waveform signal according to an electrooculogram signal waveform pattern, to determine the blink type of the blink.
